(19) United States
(12) Patent Application Publication
(10) Pub. No.: US 2026/0031683 A1
(43) Pub. Date: Jan. 29, 2026

(54) AXIAL-FLUX MACHINE WITH ROTOR COOLING ASSEMBLY

(71) Applicant: BorgWarner Inc., Auburn Hills, MI (US)

(72) Inventors: Juzer Rangwala, Mainz (DE); Daniel Härtel, Uhldingen-Mühlhofen (DE); Frank Gerber, Markdorf (DE); Tim Weiland, Worms (DE)

(21) Appl. No.: 19/280,754

(22) Filed: Jul. 25, 2025

(30) Foreign Application Priority Data
Jul. 29, 2024 (DE) 102024121558.5

(51) Int. Cl. H02K 9/10; H02K 7/14; H02K 9/04

(52) U.S. Cl. CPC H02K 9/10; H02K 7/14; H02K 9/04

(57) ABSTRACT

An axial-flux machine, particularly for a high-voltage fan, comprises a housing, at least one stator, a rotor and a rotor cooling assembly. The rotor is arranged rotatably in the housing, spaced apart from the at least one stator in the axial direction via an axial gap. The rotor cooling assembly comprises a recirculation duct which is designed as a cavity in the housing. The recirculation duct extends from radially outside to radially inside the at least one stator and is fluidically connected to the axial gap.

### CROSS-REFERENCE TO RELATED APPLICATIONS

This application claims priority pursuant to 35 U.S.C. 119(a) to German Patent Application No. 102024121558.5 filed Jul. 29, 2025, which application is incorporated herein by reference in its entirety.

### TECHNICAL FIELD

The present disclosure relates to an axial-flux machine with a rotor cooling assembly. In particular, the present disclosure relates to a high-voltage fan with a corresponding axial-flux machine.

### BACKGROUND

Electric machines have always been used in many technical sectors for the generation of kinetic energy. An electric machine is an electric device which can convert electrical energy into mechanical energy (also called an electric motor or e-motor) or conversely convert mechanical energy into electrical energy (also referred to as a generator). Kinetic energy by means of which other devices can be driven can in turn be generated with the mechanical energy. The electric motor here generally comprises a stator and a rotor which are accommodated in a motor housing. In numerous applications, the stator is fixed in its position and the rotor moves relative to the stator and usually sits on a drive shaft which co-rotates with the rotor. The rotational energy can be transmitted to other devices via the shaft. Most electric motors generate energy with a magnetic field and an alternating current. Radial-flux machines and axial-flux machines can differ in principle. In radial-flux machines, the rotor and stator are spaced radially apart from each other (by a radial gap), wherein the magnetic flux generated in a radial-flux machine is a radial flux.

In axial-flux machines, the rotor generally consists at least of a disk-shaped rotor body (also referred to as a rotor disk or disk rotor) with two circular surfaces which are connected by a thickness, wherein the disk is delimited by an outer collar and an inner circumference which delimits a space for a rotating shaft. The rotor disk carries a plurality of permanent magnets. The stator is generally designed in the shape of a disk and arranged fixedly and spaced apart axially (via an axial gap) from the rotor. The stator carries a plurality of circumferentially distributed winding elements at its side facing the rotor. Each winding element comprises in each case a stator tooth which, starting from a stator yoke, extends in an axial direction toward the rotor. A wire made from a metal material which is a good conductor is wound around the stator tooth in order to form the winding. When the windings are supplied with current, the rotor fastened at the output shaft of the motor is exposed to a torque resulting from the magnetic field, wherein the magnetic flux generated in an axial-flux machine is an axial flux. In axial-flux machines, the rotor and the stator are spaced apart in the axial direction by an axial gap and are therefore also often referred to as axial-gap machines. The permanent magnets are usually attached to one circular surface (a stator) or both circular surfaces (a rotor) of the rotor body, which is referred to as the contact surface. The rotor of an axial-flux machine can be driven by a stator on one side of the rotor or by two stators on both sides of the rotor. In the case of a rotor with a single air gap which is intended to be operated with a single stator, a single circular surface of the rotor body often carries the magnets. In the case of a rotor with two air gaps which is intended to be operated with two stators, both circular surfaces often carry the magnets. The magnets are in each case retained on the circular surface by retaining means, wherein a gap is left between the at least two magnets on the same surface. In particular in the case of axial-flux machines with two stators, the permanent magnets can also be held in pockets or windows of the rotor disk. The pockets or windows can be formed as axial recesses or axial passages through the rotor disk.

Electric motors, in particular in high-voltage applications with up to 800 volts and more, generally generate heat during operation. Excessive heat can damage internal components, limit the power supplied by the axial-flux machine, and/or adversely affect the durability of the axial-flux machine. Electric motors can be equipped with fans or radial and/or axial vents in the motor housing which can discharge at least some of the heat from the machine by drawing cooling air through various ducts in the motor housing. The heat dissipation is the limiting factor in the dimensioning of the motor and the power output. The motor current is directly related to the output power and the heat generated by the motor. Heat can be generated here both in the stators, in particular their stator windings, and in the rotor, in particular its permanent magnets. A high magnet temperature can result in an increase in the resistive losses in the stator windings because a higher input current is required in order to achieve the same torque. In addition, a higher magnet temperature can increase the risk of demagnetization and thus impair the motor power. In particular in the case of electric motor applications in the high-voltage range at which high motor powers are needed, ensuring an adequate discharge of heat is crucial. High-performance heat dissipation is necessary for this but often entails increased complexity of parts, increased manufacturing costs, and increased space requirements.

The object of the present invention is to provide an axial-flux machine with an improved compact heat dissipation which is simple to produce.

### SUMMARY

The present invention relates to an axial-flux machine according to claim 1. The invention furthermore relates to a high-voltage fan with such an axial-flux machine according to claim 16.

The axial-flux machine according to the invention comprises a housing, at least one stator, a rotor, and a rotor cooling assembly. The rotor is arranged rotatably in the housing, spaced apart from the at least one stator in the axial direction via an axial gap. The rotor cooling assembly comprises a recirculation duct which is designed as a cavity in the housing. The recirculation duct extends from radially outside to radially inside the at least one stator and is fluidically connected to the axial gap. The temperature of the rotor, in particular its permanent magnets, can be reduced by the provision of the rotor cooling assembly. As a result, the resistive losses in windings of the stator can in turn be reduced because a lower input current is required to achieve the same torque. A lower magnet temperature can additionally contribute to reducing the risk of demagnetization and thus ensures an optimal motor power. By lowering the magnet temperature it is possible to obtain a comparable power with magnets of lower quality, which results in cost savings, without adversely affecting the power and reliability of the axial-flux machine. The cooling effect can particularly advantageously furthermore be improved by the recirculation duct being designed as a cavity. Designing the recirculation duct as a cavity in the housing is to be understood such that the recirculation duct is surrounded by the housing as far as an inlet into and an outlet from the recirculation duct. The housing here serves as a heat exchanger or heat sink. Heat can thus be dissipated through the recirculation duct on all sides starting from the direction of flow.

In embodiments of the axial-flux machine, the rotor cooling assembly can be designed as a closed circuit. In particular, the rotor cooling assembly is designed as a fluidic cooling system with a heat sink/heat exchanger in the region of the recirculation duct such that heat emitted from the rotor can be collected in particular in the region of the axial gap and be dissipated to the housing in the region of the recirculation duct. In particular, the rotor cooling assembly can be designed as an air circulation cooling system.

In embodiments of the axial-flux machine, the recirculation duct can extend through the housing, axially spaced apart from the at least one stator toward an outer side of the housing. By virtue of the recirculation duct being spaced apart from the stator in the direction of an outer side of the housing, cooling power of the rotor cooling assembly can be improved.

In embodiments of the axial-flux machine, the recirculation duct can be fluidically connected to a radially inner region of the rotor. In particular, the rotor cooling assembly can comprise a feed duct section. The recirculation duct can be fluidically connected to the radially inner region of the rotor via the feed duct section.

In embodiments of the axial-flux machine, the recirculation duct can be fluidically connected to a radially outer region of the rotor. In particular, the rotor cooling assembly can comprise a discharge duct section. The recirculation duct can be fluidically connected to the radially outer region of the rotor via the discharge duct section.

In embodiments of the axial-flux machine, the recirculation duct can be formed axially between a stator retaining wall section of the housing and an outer wall section of the housing. A heat exchanger function can be implemented in particular via the outer wall section. For example, the outer wall section can be cooled by convection with ambient air outside the housing and thus function as a heat sink.

In embodiments of the axial-flux machine, the rotor cooling assembly can comprise a rotor gap duct section between the rotor and the at least one stator. An air flow can be conducted through the rotor gap duct section radially from a radially inner region of the rotor to a radially outer region of the rotor. Put in other words, the rotor gap duct section extends at least through the axial gap 60. In embodiments, the rotor gap duct section can be designed in a disk shape between the rotor and the at least one stator.

In embodiments of the axial-flux machine, the axial-flux machine can furthermore comprise a stator cooling assembly with an annular cooling duct between an inflow and a return flow. In particular, the annular cooling duct can be arranged axially adjacent to the at least one stator. In particular, the stator cooling assembly is fluidically separated from the rotor cooling assembly. In particular, the stator cooling assembly is designed so that a cooling fluid can flow through it. The cooling fluid conducted through the stator cooling assembly can comprise, for example, water and/or glycol. In embodiments, the cooling fluid can comprise in particular a glycol/water mixture (for example, in a 50%/50% ratio). By combining a rotor cooling assembly with a stator cooling assembly, the overall cooling power can be further improved.

In embodiments with the stator cooling assembly, the annular cooling duct can be formed in an outer wall section of the housing. In embodiments, the annular cooling duct can be closed from outside the housing by a cooling cover. Put in other words, the cooling duct can be formed in the outer wall section as open to the outside and (fluidically) closed by the cooling cover. In particular, the combined configuration of the recirculation duct as a cavity in the housing (in particular its outer wall section) and of the annular cooling duct in the outer wall section can improve the cooling power synergistically.

In embodiments with the stator cooling assembly, the recirculation duct can be arranged in the circumferential direction between the inflow into and the return flow from the annular cooling duct. Put in other words, the annular cooling duct of the stator and the recirculation duct are spaced apart from (but adjacent to) and separated from each other circumferentially. In particular, the annular cooling duct of the stator can extend over a range of less than 360°, for example 330° to 350°. The recirculation duct can be arranged in between (between circumferential ends of the annular cooling duct). This enables an axially overlapping (but fluidically separated) arrangement of the recirculation duct and the annular cooling duct. Axially overlapping can be understood in such a way that the recirculation duct and the annular cooling duct are arranged at least partially at the same axial position. The cooling effect, on the one hand, and an axial space requirement, on the other hand, can be reduced by the spatial proximity created as a result. By virtue of the spatial proximity, the recirculation duct or the sections of the housing which form it can be better cooled by heat exchange with the stator cooling assembly (in particular when the latter comprises water and/or glycol as the cooling fluid). Put in other words, a heat exchange function can be improved. In addition, both the recirculation duct and the annular cooling duct can be arranged (at least partially) in the outer wall section of the housing. This is advantageous because heat exchange with the air surrounding the housing can be improved the closer the recirculation duct or the annular cooling duct are arranged on an outer side of the housing.

In embodiments with the stator cooling assembly, the recirculation duct can extend circumferentially between the inflow and the return flow at least from a radially outer region of the rotor to a radially inner region of the rotor.

In embodiments of the axial-flux machine, the recirculation duct can comprise a plurality of separate recirculation part ducts. A heat exchanger function with the housing and consequently a cooling effect of the rotor cooling assembly can be improved by separate recirculation part ducts.

In embodiments of the axial-flux machine, the recirculation duct can be configured as a bore from radially outside the housing through an outer wall section of the housing. Even if an alternative manufacturing method (for example, by casting with lost cores) is technically possible, the production of the rotor cooling assembly can be simplified by the configuration of the recirculation duct as a bore. In particular in combination with a plurality of recirculation part ducts, both the cooling effect and the manufacturability can be improved synergistically. In embodiments, the recirculation duct and/or (if present) at least one of the recirculation part ducts can be introduced into the housing in a non-radial direction from a common bore opening. The course of the recirculation part ducts can deviate from a radial direction, for example, by 2° to 15°. In particular, a bore opening can be closed by a bore closure such as, for example, a bore plug.

In embodiments of the axial-flux machine, the rotor can be designed as disk-shaped. In particular, the rotor can comprise a disk-shaped rotor body. Put in other words, the rotor can also be referred to as a rotor disk.

In embodiments of the axial-flux machine, the rotor can comprise a retaining section and a plurality of permanent magnets arranged distributed in the circumferential direction. The permanent magnets can be fastened on the retaining section.

In embodiments of the axial-flux machine, the rotor can comprise a plurality of guide vanes. The guide vanes can be designed to generate a radially outward directed air flow during operation of the axial-flux machine. In particular, the radially outward directed air flow can be conducted through the rotor gap duct section, or in the case of a double stator through the rotor gap duct sections. In embodiments, the guide vanes can be formed in the retaining section. This can in particular be advantageous when the retaining section is manufactured, for example, from a plastic material. A simpler shaping process and greater degree of design freedom in comparison to being formed in a fastening section of the rotor consequently results when the latter is manufactured, for example, from a metal material (such as, for example, aluminum). In embodiments, the guide vanes can be formed at just one axial side or at both axial sides (in particular at both axial surfaces) of the rotor. In some embodiments, the plurality of guide vanes can be arranged in a radially inner region of the rotor. In particular, the guide vanes can be arranged radially immediately adjacent to the axial gap, i.e. to the region between the axial stator surface and the axial rotor surface. An amplified ventilation effect of the air in and through the axial gap can be obtained as a result.

In embodiments of the axial-flux machine, the axial-flux machine can comprise two stators. The rotor can be arranged axially spaced apart from the stators between the stators via in each case one axial gap. In embodiments, the housing can comprise a first housing part and a second housing part. A first stator of the two stators can be fastened in the first housing part (for example, cast by a resin material). A second stator of the two stators can be fastened in the second housing part (for example, cast by a resin material). The rotor cooling assembly can comprise a first recirculation duct through the first housing part and a second recirculation duct through the second housing part.

In embodiments of the axial-flux machine, the axial-flux machine can furthermore comprise a shaft which is connected non-rotatably to the rotor. In embodiments, the rotor can comprise a fastening section via which the rotor is connected non-rotatably to the shaft.

In embodiments of the axial-flux machine, the rotor can comprise at least one axial passage which fluidically connects a first axial side to a second axial side of the rotor. In embodiments, a plurality of passages can be formed in the rotor. The plurality of passages can be arranged spaced apart from one another in a circumferential direction and/or in a radial direction. An improved cooling effect can be obtained as a result. In particular when the at least one passage is formed in the fastening section, and in particular when the fastening section comprises metal material (for example, aluminum), the cooling effect can be further improved.

The present invention furthermore relates to a high-voltage fan. The high-voltage fan comprises an impeller and an axial-flux machine according to any of the preceding embodiments. The impeller can be coupled non-rotatably to the shaft outside the housing.

### BRIEF DESCRIPTION OF THE DRAWINGS

Further features can be found in the attached drawings which form part of this disclosure. The drawings are intended to further explain the present disclosure and to put a person skilled in the art in a position to practically implement the present disclosure. The drawings are, however, not to be understood as limiting examples. Common reference numerals on different Figures indicate the same or similar features.

FIG. 1 shows a perspective illustration of the high-voltage fan according to the invention with an axial-flux machine;

FIG. 2a shows a plan view of the axial-flux machine according to the invention, viewed in the axial direction;

FIG. 2b shows a schematically simplified illustration in section of the axial-flux machine along the line of section A-A from FIG. 2a in an exemplary embodiment with two stators;

FIG. 3a shows a negative model of the schematically simplified rotor cooling assembly from FIG. 2b in a perspective illustration;

FIG. 3b shows the negative model from FIG. 2b together with a negative model of the schematically simplified stator cooling assembly from FIG. 2a in a perspective illustration;

FIG. 4a shows a plan view of an exemplary embodiment of the rotor of the axial-flux machine, viewed in the axial direction;

FIG. 4b shows the detail A of the rotor from FIG. 4a;

FIG. 4c shows the detail A of the rotor from FIG. 4a in a side view rotated by 90°;

FIG. 5a shows a perspective view of the first housing part of the axial-flux machine in an exemplary embodiment;

FIG. 5b shows the detail B of the rotor from FIG. 5a in a view in partial section along the plane of section B-B;

FIG. 5c shows a detail from FIG. 5a, viewed in the direction of the arrow C;

FIG. 6a shows a plan view of the axial-flux machine in the exemplary embodiment viewed in the axial direction, the rotor and the shaft not being illustrated;

FIG. 6b shows a view in partial section along the line of section C-C from FIG. 6a, the axial-flux machine additionally being illustrated with no stators; and

FIG. 6c shows a view in section along the line of section D-D from FIG. 6a, the axial-flux machine being illustrated with schematically depicted stators.

### DETAILED DESCRIPTION

Embodiments of the axial-flux machine, the high-voltage fan, and the method according to the present disclosure will be explained below with reference to the drawings.

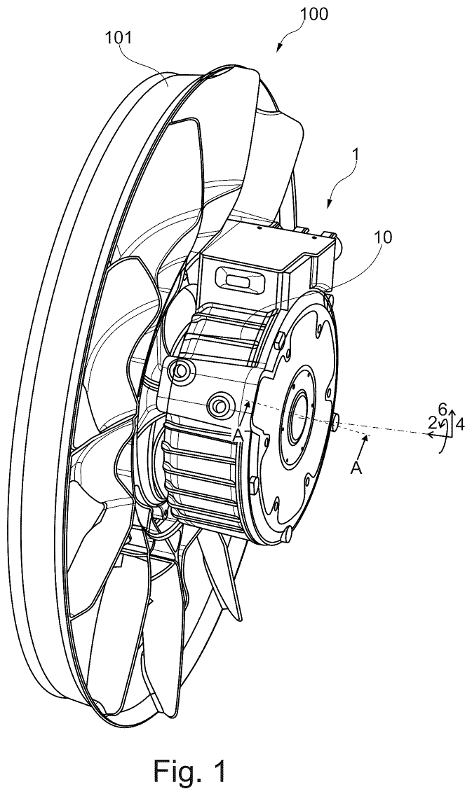

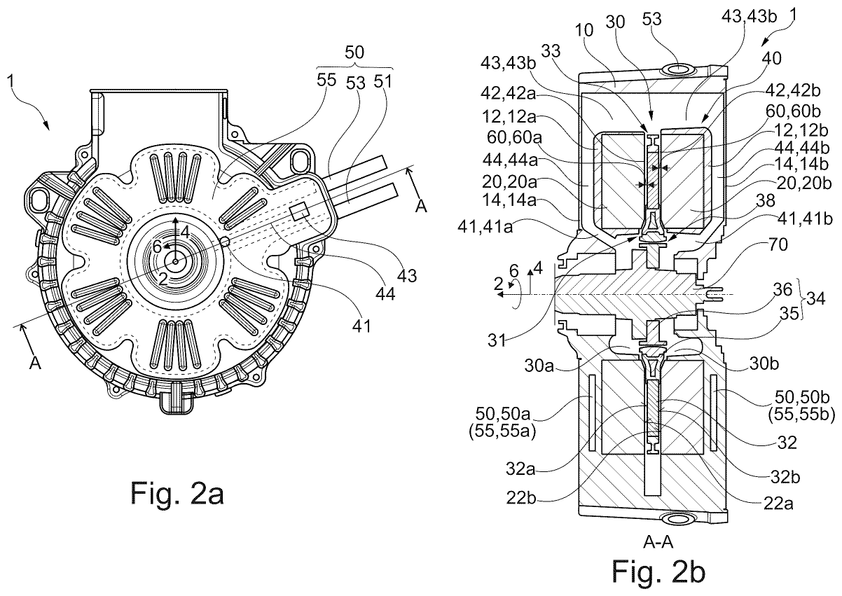

In the context of this application, the terms axial or axial direction relate to an axis of rotation of the rotor 30 (and/or of the shaft 70 and/or of the axial-flux machine 1). The axial direction 2 of the rotor 30 is illustrated with the reference sign 2 in the Figures (see, for example, FIGS. 1, 2a, 2b, 3a, 3b, 4a, 5a, 5b, 6a, 6c). The expression radial or radial direction is to be understood with reference to the axis/axial direction 2 of the rotor 30 and is illustrated with the reference sign 4. Likewise, a circumference, circumferentially, or a circumferential direction relates to the axis/axial direction 2 of the rotor 30 and is designated with the reference sign 6. It should be understood that, although in each case only one exemplary direction is illustrated in the respective Figures, the respective opposite direction also falls under the respective expression. Thus, for example, the circumferential direction 6 is illustrated in FIG. 2a by an arrow oriented counterclockwise. A clockwise direction about the axis 6 can, however, also be referred to as the circumferential direction 6. This applies analogously also for the axial direction 2 and the radial direction 4, wherein the latter can comprise any radial direction 4 starting from the axis/axial direction 2.

An exemplary high-voltage fan 100 according to the present disclosure is illustrated in FIG. 1. The fan 100 comprises an axial-flux machine 1 and an impeller 101. The impeller 101 can be driven by the axial-flux machine 1. For this purpose, the impeller 101 is arranged non-rotatably on a shaft 70 of the axial-flux machine 1 outside a housing 10 of the axial-flux machine 1. In the perspective illustration in FIG. 1, for illustrative purposes only the housing 10 and the impeller 101 can be seen. In addition, the high-voltage fan 101 can comprise a stator cooling assembly 50 in some embodiments. In this regard, cooling connectors for the supply (inflow 51) and discharge (return flow 53) of cooling fluid for cooling the axial-flux machine 1 are illustrated in FIG. 1 (see FIG. 2a). In addition, electrical connectors of the axial-flux machine 1 are illustrated. The illustrated fan 100 or its components are configured as a high-voltage fan 100. In particular, the axial-flux machine 1 can here be designed as a high-voltage axial-flux machine 1. This means that the axial-flux machine 1 is dimensioned for applications in the high-voltage range in the case of operating voltages with up to 800 volts and more. The fan 100 can in particular be used for cooling components of an electric vehicle (for example, a battery-powered electric vehicle, in particular a motor vehicle such as a car or a commercial vehicle). Alternatively, the fan 100 can also be used in further (in particular mobile) applications in which a high (cooling) power is required. In particular, included therein are also applications with an electric motor and/or internal combustion engine. For example, the fan 100 can be used in applications with similarly large-dimensioned drive motors such as an electric vehicle. Such applications can also comprise, for example, machines or vehicles with internal combustion engines and/or electric motors such as construction machines, generators, or cranes, to mention just a few examples.

FIG. 2a shows the axial-flux machine 1 according to the invention in a plan view viewed in an axial direction 2. FIG. 2b shows the axial-flux machine 1 according to the invention in a schematically simplified illustration in section along the line of section A-A from FIG. 1 or FIG. 2a. In the exemplary embodiment, the axial-flux machine 1 comprises a housing 10, two stators 20 (20a, 20b), a rotor 30, and a rotor cooling assembly 40. Even though the axial-flux machine depicted here comprises two stators 20 (20a, 20b) between which the rotor 30 is arranged, in other embodiments only one stator 20 can also be provided, the rotor 30 being arranged in the housing 10 spaced apart therefrom in the axial direction 2 via an axial gap 60. The rotor 30 is arranged rotatably in the housing 10. As illustrated further in FIGS. 2a and 2b, the rotor cooling assembly 40 comprises a recirculation duct 44. The recirculation duct 44 is designed as a cavity in the housing 10. In addition, the recirculation duct 44 extends from radially outside to radially inside the at least one stator 20 and is fluidically connected to the axial gap 60. A fluid can thus flow radially outward through the axial gap 60 and through the recirculation duct 44 radially inward back to the axial gap 60. It should be understood that the rotor cooling assembly 40 is designed as a fluid cooling system. The region of the recirculation duct 44 serves as a heat sink/heat exchanger such that heat emitted from the rotor 30 can be collected in particular in the region of the axial gap 60 and be dissipated to the housing 10 in the region of the recirculation duct 44. In particular, the rotor cooling assembly 40 can be designed as an air circulation cooling system. It should be understood that the rotor cooling assembly 40 is driven during the operation of the axial-flux machine 1, i.e. by the rotation of the rotor 30. Put in other words, air can be delivered or pumped radially outward via the rotor 30 by the centrifugal effect.

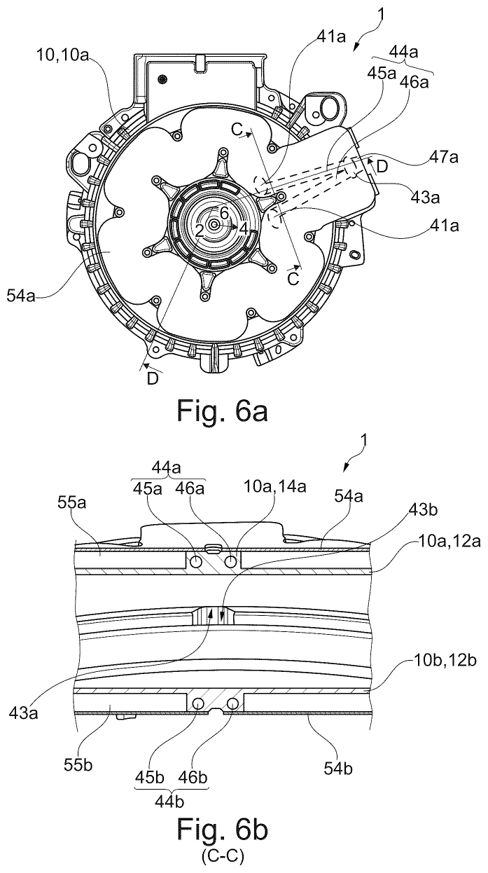

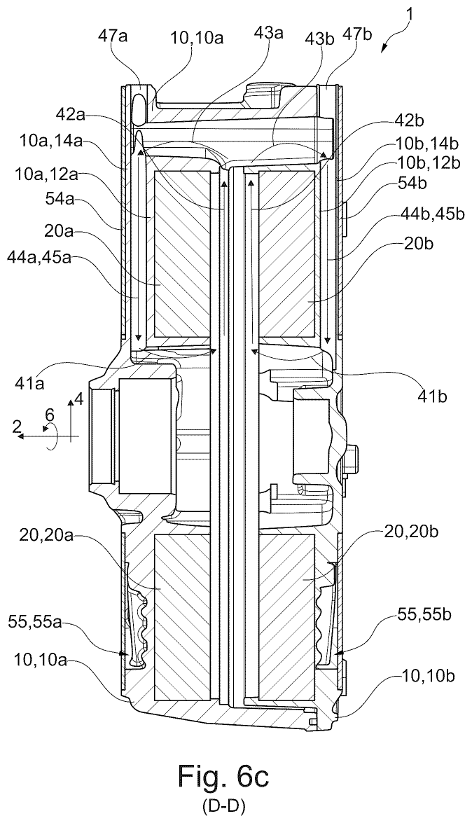

The temperature of the rotor 30, in particular its permanent magnets 32, can be reduced by the provision of the rotor cooling assembly 40. As a result, the resistive losses in windings of the stator 20 can in turn be reduced because a lower input current is required to achieve the same torque. A lower magnet temperature can additionally contribute to reducing the risk of demagnetization and thus ensures an optimal motor power. By lowering the magnet temperature it is furthermore possible to obtain a comparable power with permanent magnets of lower quality, which results in cost savings, without adversely affecting the power and reliability of the axial-flux machine 1. The cooling effect can particularly advantageously furthermore be improved by the recirculation duct 44 being designed as a cavity. Designing the recirculation duct 44 as a cavity in the housing 10 is to be understood such that the recirculation duct 44 is surrounded by the housing 10 as far as an inlet into and an outlet from the recirculation duct 44. The housing 10 here serves as a heat exchanger or heat sink. Heat can thus be dissipated through the recirculation duct 44 on all sides starting from the direction of flow (see, for example, flow directions in the direction of the arrow 44a or. 44b in FIG. 6c).

As can be seen in particular in FIG. 2a, the recirculation duct 44 extends through the housing 10 axially spaced apart from the at least one stator 20. In particular, the recirculation duct 44 is here axially spaced apart from the stator 20 toward an outer side of the housing 10. Put in other words, the stator 20 is arranged axially between the recirculation duct 44 and the rotor 30. By virtue of the recirculation duct 44 being spaced apart from the stator 20 in the direction of the outer side of the housing 10, cooling power of the rotor cooling assembly 40 can be improved. In particular, the recirculation duct 44 can be formed axially between a stator retaining wall section 12 of the housing 10 and an outer wall section 14 of the housing 10. As depicted, for example, in FIGS. 2b, 6b, or 6c, the stator retaining wall section 12 and the outer wall section 14 can enclose the recirculation duct 44. A heat exchanger function can be implemented in particular via the outer wall section 14. For example, the outer wall section 14 can be cooled by convection with ambient air outside the housing 10 and thus function as a heat sink.

In particular, the rotor cooling assembly 40 can be designed as a closed circuit (see FIGS. 2b and 6c). The recirculation duct 44 can be fluidically connected to a radially inner region 31 of the rotor 30. In addition, the recirculation duct 44 can be fluidically connected to a radially outer region 33 of the rotor 30. A fluid circuit can thus circulate from the radially inner region 31 of the rotor 30, through the axial gap 60, to the radially outer region 33 of the rotor 30, onward into the recirculation duct 44 and back to the radially inner region of the rotor 30. In particular, the rotor cooling assembly 40 can comprise a feed duct section 41. The recirculation duct 44 can be fluidically connected to the radially inner region 31 of the rotor 30 via the feed duct section 41. In particular, the rotor cooling assembly 40 can comprise a discharge duct section 43. The recirculation duct 44 can be fluidically connected to the radially outer region 33 of the rotor 30 via the discharge duct section 43. In particular, the rotor cooling assembly 40 can comprise a rotor gap duct section 42 between the rotor 30 and the at least one stator 20. A fluid flow (in particular an air flow) can be conducted through the rotor gap duct section 42 radially from the radially inner region 31 of the rotor 30 to a radially outer region 33 of the rotor 30. Put in other words, the rotor gap duct section 42 extends at least through the axial gap 60. In embodiments, the rotor gap duct section 42 can be designed in a disk shape between the rotor 30 and the at least one stator 20. The closed circuit with the feed duct section 41 (41a, 41b), the rotor gap duct section 42 (42a, 42b), the discharge duct section 43 (43a, 43b), and the recirculation duct 44 (44a, 44b) is illustrated in FIG. 6c schematically by the corresponding arrows. It should be understood that the rotor cooling assembly can be fluidically sealed by corresponding seals (not depicted) in the region between the housing 10 and the shaft 70 of the axial-flux machine 1.

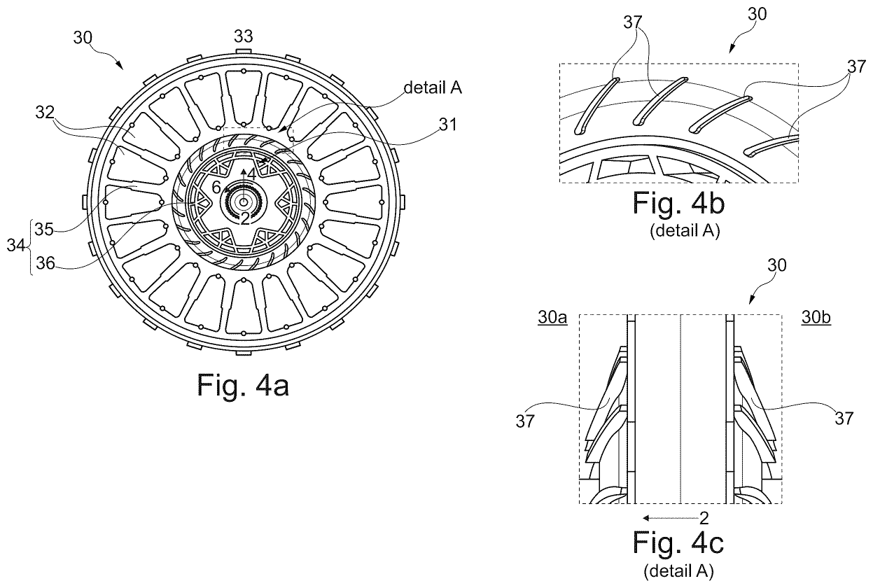

As can be seen clearly in particular in FIGS. 2b and 4a, the rotor 30 can be designed as disk-shaped. In particular, the rotor 30 can comprise a disk-shaped rotor body 34. Put in other words, the rotor 30 can also be referred to as a rotor disk 30. In embodiments, the rotor 30 or its rotor body 34 can comprise a retaining section 35. In addition, the rotor 30 can comprise a plurality of permanent magnets 32 arranged distributed in the circumferential direction 6. As illustrated in FIG. 2b, a first axial side 30a and an opposite second axial side 30b can be defined with respect to the rotor 30. Within the scope of the present disclosure, the first axial side 30a can also be described as the front side 30a and the second axial side can also be described as the rear side 30b. The axial sides 30a, 30b are to be understood in relation to an axially central region at which the permanent magnets 32 are arranged. The rotor disk 30, in particular its permanent magnets 32, define a first axial rotor surface 32a and an opposite second axial rotor surface 32b.

In light of the present disclosure, an “axial surface” can be understood as a surface with a normal vector pointing essentially in the axial direction 2. “Essentially in the axial direction 2” can here include deviations of up to 5°, in particular up to 3°. For example, the axial rotor surface 30a points toward the first axial side 30a in the axial direction 2.

The permanent magnets 32 can be fastened on the retaining section 35 (see FIGS. 2b and 4a). For example, the retaining section 35 can be designed as a plastic overmolding by means of which the permanent magnets 32 are overmolded and consequently fixed. The permanent magnets 32 can be at least partially free of plastic overmolding at the axial rotor surfaces 32a, 32b. It should be understood that other fastening methods are also possible for the permanent magnets 33. Nevertheless, the solution with a plastic overmolded retaining section 35 affords the advantage that a non-metal material (and thus a material which is not electrically conductive or a material which is at least less electrically conductive as a metal material) is used in the magnetically active region between the stators 20. Eddy current losses during operation can consequently be reduced.

Furthermore with reference to FIG. 2b, the axial-flux machine 1 can comprise a shaft 1 which is connected non-rotatably to the rotor 30. In embodiments, the rotor 30 or its rotor body 34 can comprise a fastening section 36 via which the rotor 30 is connected non-rotatably to the shaft 70. The fastening section 36 can be formed from a material (for example, a metal material such as aluminum or ceramic material) of greater strength than the retaining section 35 (for example, a plastic material, in particular an electrically insulating material). In particular, the material of the retaining section 35 can have a lower electrical and/or thermal conductivity than the material of the fastening section 36. This has the advantage that, by virtue of the fastening section 36, the rotor 30 acquires a strengthening property and, on the other hand, by virtue of the non-metallic retaining section 35, it acquires a property of reducing eddy current losses. Alternatively, a few embodiments of the rotor body 34 (i.e. the retaining section 35 and the fastening section 36) can be manufactured from one part and/or material. In some embodiments, the rotor body 34, in particular its fastening section 36, can be manufactured as a single piece with the shaft 70.

In some embodiments, the rotor 30 can comprise at least one axial passage 38 which fluidically connects the first axial side 30a to the second axial side 30b of the rotor 30. In embodiments, a plurality of passages 38 can be formed in the rotor 30. In this regard, two circumferentially spaced-apart passages 38 can be seen by way of example in FIG. 2b. FIG. 4a shows an example in which a plurality of passages 38 are arranged spaced apart in the circumferential direction 6 and/or in the radial direction 4. As can be seen in FIG. 4a, the plurality of passages 38 are formed by way of example in the fastening section 36. In other examples, the passages 38 can alternatively or additionally be formed in the retaining section 35. An improved cooling effect can be obtained by the passages 38. The cooling effect can be further improved in particular when the at least one passage 38 is formed in the fastening section 36 and in particular when the fastening section comprises metal material (for example, aluminum).

As already mentioned, an axial-flux machine 1 can comprise at least one stator 20, for example only one stator 20 (single stator) or two stators 20 (double stator). Illustrated in FIGS. 2b and 6c by way of example is an axial-flux machine 1 with two stators 20. As depicted, the two stators 20 comprise a first stator 20a and a second stator 20b. Each of the stators 20a, 20b can have an annular stator yoke with a plurality of stator teeth (not illustrated in detail) which extend from the stator yoke in an axial direction 2 toward the rotor 30, distributed in the circumferential direction 6. Electrical lines (not illustrated) are wound around the stators 20a, 20b or their stator teeth in order to form windings. As already mentioned, in FIGS. 2b and 6c is an illustration of the axial-flux machine 1 which is schematically simplified such that the details, for example of the stators 20a, 20b, cannot be seen in detail. When a driving current is applied to the windings, a magnetic field can be generated which is suitable for acting on the rotor 30 or its permanent magnets 32 and driving the latter.

The rotor 30 is arranged axially between the first stator 20a and the second stator 20b. The first stator 20a is arranged on the first axial side 30a relative to the rotor 30 and can therefore also be referred to as a front stator 20a. The second stator 20b is arranged on the second axial side 30b relative to the rotor 30 and can therefore also be referred to as a rear stator 20b. The rotor 30 can be arranged axially between the stators 20a, 20b, spaced apart from the stators 20a, 20b via in each case one axial gap 60a, 60b. Expressed alternatively, in each case an air gap 60a, 60b (which is visible in FIG. 2b) is provided in the axial direction 2 between the rotor 30 and the stators 20a, 20b. These air gaps 60a extend in an axial direction 2 and can therefore also be referred to as an axial air gap or axial gap 60a, 60b. To be more precise, a first axial gap 60a (also referred to as a front axial gap 60a) is formed between the first stator 20a and the rotor 30. A second axial gap 60b (also referred to as a rear axial gap 60b) is formed between the second stator 20b and the rotor 30. The first stator 20a defines a first axial stator surface 22a which points toward the rotor 30 or is situated opposite the first axial rotor surface 32a. The second stator 20b defines a second axial stator surface 22b which points toward the rotor 30 or is situated opposite the second axial rotor surface 32b. The front axial gap 60a extends from the first axial stator surface 22a to the first axial rotor surface 32a. The rear axial gap 60b extends from the second axial stator surface 22b to the second axial rotor surface 32b.

As illustrated in FIG. 6c, the housing 10 can comprise a first housing part 10a (also referred to as a front housing part 10a) and a second housing part 10b (also referred to as a rear housing part 10b). The first stator 20a can be fastened in the first housing part 10a (for example, cast by a resin material). The second stator 20b can be fastened in the second housing part 10b (for example, cast by a resin material). The rotor cooling assembly 40 can comprise a first recirculation duct 44a through the first housing part 10a and a second recirculation duct 44b through the second housing part 10b. It should be understood that the first recirculation duct 44a and/or the second recirculation duct 44b can have one or more features of the recirculation duct 44 described generally as part of the present disclosure. In other words, two fluid circuits (in particular two air flows) with an opposite orientation, as illustrated schematically in FIG. 6c, can be generated through the two recirculation ducts 44a, 44b during operation of the axial-flux machine 1 (i.e. when the rotor 30 is rotating). In detail, a first fluid circuit can be provided by a first feed duct section 41a, by a first rotor gap duct section 42a, by a first discharge duct section 43a, and by the first recirculation duct 44a (see FIG. 6c, illustrated schematically by the corresponding arrows on the left-hand side). Furthermore, a second fluid circuit can be provided by a second feed duct section 41b, by a second rotor gap duct section 42b, by a second discharge duct section 43b, and by the second recirculation duct 44b (see FIG. 6c, illustrated schematically by the corresponding arrows on the right-hand side). In alternative embodiments with two stators 20a, 20b, only a single fluid circuit (on the right-hand or left-hand side) can also be formed. It should nevertheless be understood that the cooling effect can be significantly improved by two recirculation ducts 44a, 44b and corresponding fluid circuits.

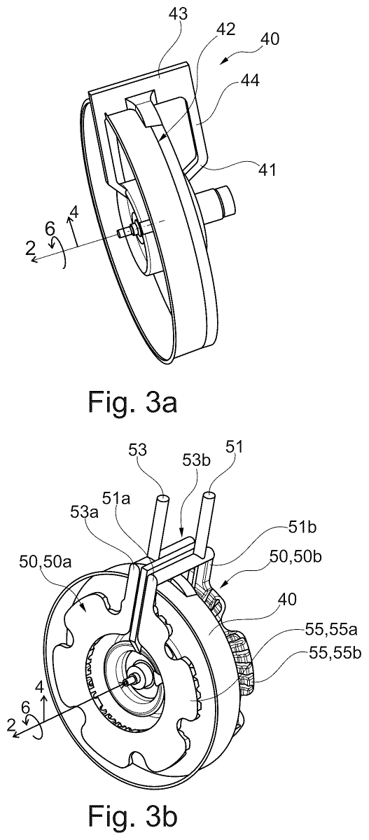

In particularly advantageous embodiments, the axial-flux machine 1 can comprise a stator cooling assembly 50 (in particular in addition to the rotor cooling assembly 40). The stator cooling assembly 50 comprises an annular cooling duct 55 between an inflow 51 and a return flow 53 (see FIGS. 2a, 2b, 3b, 5b, 6b, 6c). The annular cooling duct 55 is indicated schematically in FIG. 2a by the dashed line. As illustrated in particular in FIGS. 2b and 6c, the annular cooling duct 55 can be arranged axially spaced apart from the at least one stator 20. As shown, in embodiments with a first stator 20a and a second stator 20b, the stator cooling assembly 50 can comprise in particular two annular cooling ducts 55a, 55b with a first annular cooling duct 55a and a second annular cooling duct 55b. As can be seen in particular in FIG. 3b, the two annular cooling ducts 55a, 55b can be fed from a common inflow 51 and a common return flow 53. The common inflow 51 can split into a first inflow 51a and a second inflow 51b. The common return flow 53b can merge from a first return flow 53a and a second return flow 53b. Alternatively, the first/second inflow 51a, 51b and/or return flow 53a, 53b can lead separately to the respective first and second annular cooling duct 55a, 55b. The stator cooling assembly 50 is in particular fluidically separated from the rotor cooling assembly 40. In particular, the stator cooling assembly 50 is designed so that a cooling fluid flows through it. The cooling fluid conducted through the stator cooling assembly 50 can comprise, for example, water and/or glycol. In embodiments, the cooling fluid can comprise in particular a glycol/water mixture (for example, in a 50%/50% ratio). The overall cooling power can be further improved by combining a rotor cooling assembly 40 with a stator cooling assembly 50. It should be understood that the first annular cooling duct 55a and/or the second annular cooling duct 55b can have one or more features of the annular cooling duct 55b described generally as part of the present disclosure.

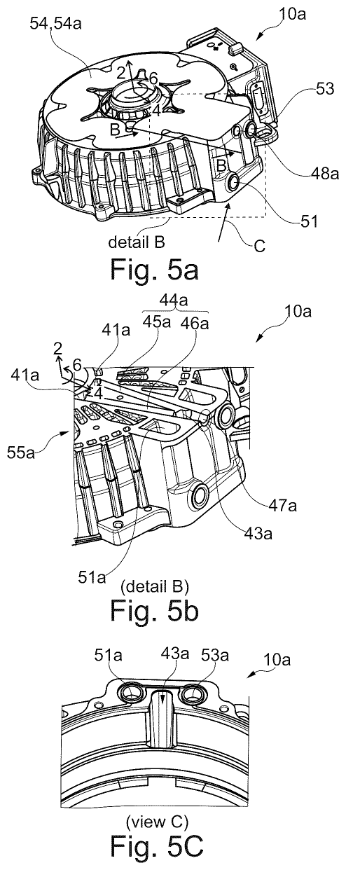

As can be seen in particular in FIG. 6c, the annular cooling duct 55 can be formed in an outer wall section 14 of the housing 10. In particular, the annular cooling duct 55 can be closed from outside the housing 10 by a cooling cover 54 (see FIGS. 5a, 6a, 6b, 6c). Put in other words, the cooling duct 55 can be formed in the outer wall section as open to the outside and (fluidically) be closed by the cooling cover 54. In particular, the combined configuration of the recirculation duct 44 as a cavity in the housing 10 (in particular its outer wall section 14) and of the annular cooling duct 55 in the outer wall section 14, can synergistically improve the cooling power. It should be understood that the stator cooling assembly 50 can have two cooling covers 54 (i.e. a first cooling cover 54a and a second cooling cover 54b) when two annular cooling ducts 55a, 55b are provided (see in particular FIGS. 6b and 6c).

In embodiments, the recirculation duct 44 can be arranged in the circumferential direction 6 between the inflow 51 into and the return flow 53 from the annular cooling duct 55 (see FIGS. 2a, 3a, 3b, 5b). Put in other words, the annular cooling duct 55 of the stator 20 and the recirculation duct 44 are spaced apart from (but adjacent to) and separated from each other circumferentially. In particular, the recirculation duct 44 can extend circumferentially between the inflow 51 and the return flow 53 at least from the radially outer region 33 of the rotor 30 to the radially inner region 31 of the rotor 30. In embodiments, the annular cooling duct 55 and the recirculation duct 44 can be arranged as axially overlapping (but fluidically separated). This can be seen in particular in FIGS. 3a and 3b in the schematic negative models of the rotor cooling assembly 40 and the stator cooling assembly 50. In this regard, FIG. 3a shows a schematic negative model of the rotor cooling assembly 40. FIG. 3b shows the relative arrangement of the rotor cooling assembly 40 from FIG. 3a together with a negative model of the stator cooling assembly 50. It is also clear here that the annular cooling duct 55 of the stator 20 extends over a range of less than 360°. For example, the annular cooling duct 55 can extend over 330° to 350°. The recirculation duct 44 can here be arranged circumferentially between circumferential ends of the annular cooling duct 55 (see FIGS. 2a and 3b). This enables an axially overlapping (but fluidically separated) arrangement of the recirculation duct 44 and the annular cooling duct 55. Axially overlapping can be understood in such a way that the recirculation duct 44 and the annular cooling duct 55 are arranged at least partially at the same axial position (see in particular FIGS. 3b, 5b, 6b, and 6c). By virtue of the spatial proximity generated as a result, on the one hand the cooling effect (in particular also a heat exchange between the rotor cooling assembly 40 or its recirculation duct 44 and the stator cooling assembly 50 or its annular cooling duct 55), and on the other hand an axial space requirement for the axial-flux machine 1 are reduced. By virtue of the spatial proximity, the recirculation duct 44 or the sections of the housing 10 which form it can be better cooled by heat exchange with the stator cooling assembly 50 (in particular when the latter comprises water and/or glycol as the cooling fluid). Put in other words, a heat exchange function can be improved. In addition, both the recirculation duct 44 and the annular cooling duct 55 can be arranged (at least partially) in the outer wall section 14 of the housing 10. This is advantageous because heat exchange with the air surrounding the housing 10 can be improved the closer the recirculation duct 44 or the annular cooling duct 55 are arranged on an outer side of the housing 10.

FIGS. 5a, 5b, 5c, 6a, 6b, and 6c show an exemplary embodiment of the axial-flux motor 1 which can comprise one or more features of the axial-flux motor 1 described in the present disclosure. In particular, the recirculation duct 44 can comprise a plurality of separate recirculation part ducts 45, 46. A heat exchanger function with the housing 10 and consequently a cooling effect of the rotor cooling assembly 40 can be improved by separate recirculation part ducts 45, 46. As already mentioned, the first recirculation duct 44a and/or the second recirculation duct 44b can be designed as the recirculation duct 44 described generally in the present disclosure. For example, in embodiments with two recirculation ducts 44a, 44b, the first recirculation duct 44a and/or the second recirculation duct 44b can comprise a plurality of separate recirculation part ducts 45a, 45b, 46a, 46b. For example, the first recirculation duct 44a can comprise a first recirculation duct 45a and a second recirculation duct 46a (see FIGS. 5b, 6a, 6b). Alternatively or additionally, the second recirculation duct 44b can comprise a first recirculation part duct 45b and a second recirculation part duct 46b. Also, just one of the two recirculation ducts 44a, 44b could comprise more than one recirculation part duct. In embodiments, the recirculation duct 44 could also comprise more than two recirculation part ducts 45, 46. In embodiments, the recirculation part ducts 45a, 46a can be fluidically connected to the radially inner region 31 of the rotor 30 via a common feed duct section 41 or, as illustrated schematically in FIG. 6a, via in each case a feed duct section 41a. Analogously, the recirculation part ducts 45a, 46a can be fluidically connected to the radially outer region 33 of the rotor 30 via in each case one discharge duct section 43 or, as illustrated schematically in FIG. 6a, via a common discharge duct section 43a.

In embodiments, the recirculation duct 44, if present optionally also the first recirculation part duct 45 (45a, 45b) and/or the second recirculation part duct 46 (46a, 46b), can be configured as a bore from radially outside the housing 10 into the housing 10 (see FIGS. 5b, 6a, 6c). In particular, the bore can extend from radially outside the housing 10 into the outer wall section 14 of the housing. In particular, a bore opening 47 of the recirculation duct 44 can be closed by a bore closure 48 such as, for example, a bore plug. In this regard, FIGS. 5a, 5b, 5c show by way of example the first housing part 10a. FIG. 5b here shows the first housing part 10a in a partial view in section in which the first housing part 10a is sectioned by an axial plane which runs through the line of section B-B. By virtue of this view in section, the (first) recirculation duct 44 (44a) with the (first) recirculation part duct 45 (45a) and the second recirculation duct 46 (46a) as well as the bore opening 47a is visible axially below the first cooling cover 54a. The bore closure 48a is shown by way of example in FIG. 5a. As illustrated in FIG. 5b, the two recirculation part ducts 45a, 46a can run radially inward from a common bore opening 47, designated here by the reference sign 47a because it relates to the first housing part 10a. Alternatively, a plurality of bore openings 47 could also be provided, in particular in each case one bore opening 47 for each recirculation part duct 45, 46. Even though an alternative manufacturing method (for example, by casting with lost cores) is technically possible, the production of the rotor cooling assembly 40 can be simplified by the configuration of the recirculation duct 44 as a bore. In particular in combination with a plurality of recirculation part ducts 45, 46, both the cooling effect and the manufacturability can be improved synergistically. In embodiments, the recirculation duct 44 and/or (if present) at least one of the recirculation part ducts 45, 46 run in a non-radial direction 4 (see FIGS. 5b and 6a). The course of the recirculation duct 44 and/or (if present) of at least one of the recirculation part ducts 45, 46 can deviate from the radial direction 4, for example, by 2° to 15°. In some embodiments, the recirculation part ducts 45, 46 can be introduced into the housing 10 from a common bore opening 47 in a non-radial direction 4.

In some embodiments, the rotor 30 can comprise a plurality of guide vanes 37 (see FIGS. 4a, 4b, 4c). The guide vanes 37 can be designed to generate a radially outward directed air flow during operation of the axial-flux machine 1. In particular, the radially outward directed air flow can be conducted through the rotor gap duct section 42, or in the case of a double stator through the rotor gap duct sections 42 (42a, 42b). In embodiments, the guide vanes 37 can be formed in the retaining section 35. This can in particular be advantageous when the retaining section 35 is manufactured, for example, from a plastic material. A simpler shaping process and greater degree of design freedom in comparison to being formed in a fastening section 36 of the rotor 30 consequently results when the latter is manufactured, for example, from a metal material (such as, for example, aluminum). In embodiments, the guide vanes 37 can be formed at just one axial side or, as shown in FIG. 4c, at both axial sides 30a, 30b (in particular at both axial surfaces 32a, 32b) of the rotor 30. In some embodiments, the plurality of guide vanes 37 can be arranged in a radially inner region 31 of the rotor 30. In particular, the guide vanes 37 can be arranged radially immediately adjacent to the axial gap 60 (60a, 60b), i.e. adjacent to the region between the axial stator surface 22a, 22b and the axial rotor surface 32a, 32b. An amplified ventilation effect of the air in and through the axial gap 60 (60a, 60b) can be obtained as a result.

Although the present invention has been described above and is defined in the attached claims, it should be understood that the invention can alternatively also be defined according to the following embodiments:

1. An axial-flux machine (1) comprising:
a housing (10),
at least one stator (20), and
a rotor, (30) which is arranged rotatably in the housing (10), spaced apart from the at least one stator (20) in the axial direction (2) via an axial gap (60), and a rotor cooling assembly (40) with a recirculation duct (44) which is designed as a cavity in the housing (10), wherein the recirculation duct (44) extends from radially outside to radially inside the at least one stator (20) and is fluidically connected to the axial gap (60).

2. The axial-flux machine (1) according to embodiment 1, wherein the rotor cooling assembly (40) is designed as a closed circuit.

3. The axial-flux machine (1) according to any of the preceding embodiments, wherein the recirculation duct (44) extends through the housing (10), axially spaced apart from the at least one stator (20) toward an outer side of the housing (10).

4. The axial-flux machine (1) according to any of the preceding embodiments, wherein the recirculation duct (44) is fluidically connected to a radially inner region (31) of the rotor (30).

5. The axial-flux machine (1) according to embodiment 4, wherein the rotor cooling assembly (40) comprises a feed duct section (41) via which the recirculation duct (44) is fluidically connected to the radially inner region (31) of the rotor (30).

6. The axial-flux machine (1) according to any of the preceding embodiments, wherein the recirculation duct (44) is fluidically connected to a radially outer region (33) of the rotor (30).

7. The axial-flux machine (1) according to embodiment 6, wherein the rotor cooling assembly (40) comprises a discharge duct section (43) via which the recirculation duct (44) is fluidically connected to the radially outer region (33) of the rotor (30).

8. The axial-flux machine (1) according to any of the preceding embodiments, wherein the recirculation duct (44) is formed axially between a stator retaining wall section (12) of the housing (10) and an outer wall section (14) of the housing (10).

9. The axial-flux machine (1) according to any of the preceding embodiments, wherein the rotor cooling assembly (40) comprises a rotor gap duct section (42) between the rotor (30) and the at least one stator (20) through which an air flow can be conducted radially from a radially inner region (31) of the rotor (30) to a radially outer region (33) of the rotor (30).

10. The axial-flux machine (1) according to embodiment 9, wherein the rotor gap duct section (42) is designed as disk-shaped between the rotor (30) and the at least one stator (20).

11. The axial-flux machine (1) according to any of the preceding embodiments, furthermore comprising a stator cooling assembly (50) with an annular cooling duct (55) between an inflow (51) and a return flow (53), optionally
wherein the annular cooling duct (55) and the recirculation duct (44) are arranged as at least partially axially overlapping, and/or
wherein the recirculation duct (44) is arranged in the circumferential direction (6) between circumferential ends of the annular cooling duct (55).

12. The axial-flux machine (1) according to embodiment 11, wherein the annular cooling duct (55) is formed in an outer wall section (14) of the housing (10).

13. The axial-flux machine (1) according to embodiment 12, wherein the annular cooling duct (55) is closed from outside the housing (10) by a cooling cover (54).

14. The axial-flux machine (1) according to any of embodiments 11 to 13, wherein the recirculation duct (44) is arranged in the circumferential direction (6) between the inflow (51) and the return flow (53).

15. The axial-flux machine (1) according to any of embodiments 11 to 14, wherein the recirculation duct (44) extends circumferentially between the inflow (51) and the return flow (53) at least from a radially outer region (33) of the rotor (30) to a radially inner region (31) of the rotor (30).

16. The axial-flux machine (1) according to any of the preceding embodiments, wherein the recirculation duct (44) comprises a plurality of separate recirculation part ducts (45, 46).

17. The axial-flux machine (1) according to any of the preceding embodiments, wherein the recirculation duct (44) is configured as a bore from radially outside the housing (10) through an outer wall section (14) of the housing (10).

18. The axial-flux machine (1) according to any of the preceding embodiments, wherein the rotor (30) is designed as disk-shaped, in particular wherein the rotor (30) comprises a disk-shaped rotor body (34).

19. The axial-flux machine (1) according to any of the preceding embodiments, wherein the rotor (30) comprises a retaining section (35) and a plurality of permanent magnets (32) arranged distributed in the circumferential direction (6) which are fastened on the retaining section (35).

20. The axial-flux machine (1) according to any of the preceding embodiments, wherein the rotor (30) comprises a plurality of guide vanes (37) which are designed to generate a radially outward directed air flow during operation of the axial-flux machine (1).

21. The axial-flux machine (1) according to embodiment 20, wherein the plurality of guide vanes (37) are arranged in a radially inner region (31) of the rotor (30).

22. The axial-flux machine (1) according to any of the preceding embodiments, wherein the axial-flux machine (1) comprises two stators (20a, 20b), and wherein the rotor (30) is arranged axially spaced apart from the stators (20a, 20b) between the stators (20a, 20b) via in each case one axial gap (60a, 60b).

23. The axial-flux machine (1) according to embodiment 22, wherein the housing (10) comprises a first housing part (10a) and a second housing part (10b), wherein a first stator (20a) of the two stators (20a, 20b) is fastened in the first housing part (10a) and a second stator (20b) of the two stators (20a, 20b) is fastened in the second housing part (10b), and wherein the rotor cooling assembly (40) comprises a first recirculation duct (44a) through the first housing part (10a) and a second recirculation duct (44b) through the second housing part (10b).

24. The axial-flux machine (1) according to any of the preceding embodiments, furthermore comprising a shaft (70) which is connected non-rotatably to the rotor (30).

25. The axial-flux machine (1) according to embodiment 24, wherein the rotor (30) comprises a fastening section (36) via which the rotor (30) is connected non-rotatably to the shaft (70).

26. The axial-flux machine (1) according to any of the preceding embodiments, wherein the rotor (30) comprises at least one axial passage (38) which fluidically connects a first axial side (30a) to a second axial side (30b) of the rotor (30).

27. A high-voltage fan (100) comprising an impeller (101) and an axial-flux machine (1) according to any of the preceding embodiments, if dependent at least on embodiment 24, wherein the impeller (101) is coupled non-rotatably to the shaft (70) outside the housing (10).

### REFERENCE SIGNS

1 axial-flux machine
2 axial direction
4 radial direction
6 circumferential direction
10 housing
10a first housing part
10b second housing part
12 (12a/12b) stator retaining wall section (first/second)
14 (14a/14b) outer wall section (first/second)
20 (20a/20b) stator (first/second)
22a first axial stator surface
22b second axial stator surface
30 rotor
30a first axial side
30b second axial side
31 radially inner region
32 permanent magnet
32a first axial rotor surface
32b second axial rotor surface
33 radially outer region
34 rotor body
35 retaining section
36 fastening section
37 guide vanes
38 passage
40 rotor cooling assembly
41 (41a/41b) feed duct section (first/second)
42 (42a/42b) rotor gap duct section (first/second)
43 (43a/43b) discharge duct section (first/second)
44 (44a/44b) recirculation duct (first/second)
45 (45a, 45b) first recirculation part duct
46 (46a, 46b) second recirculation part duct
47 (47a) bore opening (first)
48 (48a) bore closure (first)
50 stator cooling assembly
51 (51a/51b) inflow (first/second)
53 (53a/53b) return flow (first/second)
54 (54a/54b) cooling cover (first/second)
55 (55a/55b) annular cooling duct (first/second)
60 (60a/60b) axial gap (first/second)
70 shaft
100 high-voltage fan
101 impeller

What is claimed is:

1. An axial-flow machine comprising:
a housing,
at least one stator, and
a rotor, which is arranged rotatably in the housing, spaced apart from the at least one stator in the axial direction via an axial gap, and
a rotor cooling assembly with a recirculation duct which is designed as a cavity in the housing, wherein the recirculation duct extends from radially outside to radially inside the at least one stator and is fluidically connected to the axial gap.

2. The axial-flow machine as claimed in claim 1, wherein the rotor cooling assembly is a closed circuit.

3. The axial-flow machine as claimed in claim 2, wherein the recirculation duct extends through the housing, axially spaced apart from the at least one stator toward an outer side of the housing.

4. The axial-flow machine as claimed in claim 1, wherein the recirculation duct extends through the housing, axially spaced apart from the at least one stator toward an outer side of the housing.

5. The axial-flow machine as claimed in claim 1, wherein the recirculation duct is fluidically connected to a radially inner region of the rotor, and wherein the rotor cooling assembly comprises a feed duct section via which the recirculation duct is fluidically connected to the radially inner region of the rotor.

6. The axial-flow machine as claimed in claim 2, wherein the recirculation duct is fluidically connected to a radially inner region of the rotor, and wherein the rotor cooling assembly comprises a feed duct section via which the recirculation duct is fluidically connected to the radially inner region of the rotor.

7. The axial-flow machine as claimed in claim 3, wherein the recirculation duct is fluidically connected to a radially inner region of the rotor, and wherein the rotor cooling assembly comprises a feed duct section via which the recirculation duct is fluidically connected to the radially inner region of the rotor.

8. The axial-flow machine as claimed in claim 1, wherein the recirculation duct is fluidically connected to a radially outer region of the rotor, and wherein the rotor cooling assembly comprises a discharge duct section via which the recirculation duct is fluidically connected to the radially outer region of the rotor.

9. The axial-flow machine as claimed in claim 1, wherein the recirculation duct is formed axially between a stator retaining wall section of the housing and an outer wall section of the housing.

10. The axial-flow machine as claimed in claim 1, wherein the rotor cooling assembly comprises a rotor gap duct section between the rotor and the at least one stator through which an air flow can be conducted radially from a radially inner region of the rotor to a radially outer region of the rotor.

11. The axial-flow machine as claimed in further comprising a stator cooling assembly with an annular cooling duct between an inflow and a return flow, wherein the annular cooling duct and the recirculation duct are arranged as at least partially axially overlapping.

12. The axial-flow machine as claimed in claim 11, wherein the recirculation duct is arranged in the circumferential direction between the inflow and the return flow, and wherein the recirculation duct extends circumferentially between the inflow and the return flow at least from a radially outer region of the rotor to a radially inner region of the rotor.

13. The axial-flow machine as claimed in claim 1, wherein the recirculation duct comprises a plurality of separate recirculation subducts.

14. The axial-flow machine as claimed in claim 1, wherein the recirculation duct is configured as a bore from radially outside the housing into the housing.

15. The axial-flow machine as claimed in claim 1, wherein the rotor comprises a plurality of guide vanes which are configured to generate a radially outward directed air flow during operation of the axial-flow machine.

16. The axial-flow machine as claimed in claim 1, wherein the axial-flow machine comprises two stators, and wherein the rotor is arranged axially spaced apart from the stators between the stators via in each case one axial gap.

17. The axial-flow machine as claimed in claim 16, wherein the housing comprises a first housing part and a second housing part, wherein a first stator of the two stators is fastened in the first housing part and a second stator of the two stators is fastened in the second housing part, and wherein the rotor cooling assembly comprises a first recirculation duct through the first housing part and a second recirculation duct through the second housing part.

18. The axial-flow machine as claimed in claim 1, wherein the rotor comprises at least one axial passage which fluidically connects a first axial side to a second axial side of the rotor.

19. A high-voltage fan comprising an impeller and an axial-flow machine as claimed in claim 1, wherein the axial-flow machine furthermore comprises a shaft which is connected non-rotatably to the rotor, wherein the impeller is coupled non-rotatably to the shaft outside the housing.
